(19) United States
(12) Patent Application Publication
(10) Pub. No.: US 2008/0103735 A1
(43) Pub. Date: May 1, 2008

(54) SYSTEM AND METHOD FOR DEFINING THE FREQUENCY OF PRODUCT MAINTENANCE

(76) Inventors: Roger Morenc, Aiken, SC (US); Mark Bradley, Irving, TX (US); Mark Richmond, Irving, TX (US)

Correspondence Address: SIEMANS PRODUCT LIFECYCLE MANAGEMENT SOFTWARE INC., 5800 GRANITE PARKWAY, SUITE 600, PLANO, TX, 75024, US

(21) Appl. No.: 11/553,874

(22) Filed: Oct. 27, 2006

(51) Int. Cl. G06F 7/48

(52) U.S. Cl. 703/2

(57) ABSTRACT

A system, method, and computer program for defining a maintenance frequency of a product, comprising the steps of building a frequency expression for a product element based on a frequency expression language; and associating an action with said frequency expression and appropriate means and computer-readable instructions.

### TECHNICAL FIELD

The presently preferred embodiment of the innovations described herein relate generally to product maintenance. More specifically, the presently preferred embodiment relates to defining a frequency expression language for product maintenance.

### BACKGROUND

In the process of managing the entire lifecycle of a product, from conception through design and manufacture, an often minimized phase is that of support. To service and sustain the product, maintenance is extremely important, particularly for complex, safety-critical products. The definition of when to perform maintenance—referred to as the frequency of performing a maintenance action—is itself complex. The complex products produced require many different maintenance actions over time, and each of these maintenance actions can require completely different frequencies. The frequencies themselves can depend on various factors, e.g., different life or usage characteristics, dependencies on other maintenance, repeating intervals, etc. Unfortunately, the commercial products available today handle only about 80% of the necessary product maintenance, which can result in substantial loss of life should a critical failure occur

What is needed is a method to define the frequency of doing required product maintenance that covers a great percentage of the frequency cases to increase product life and minimize risk to human life.

### SUMMARY

To achieve the foregoing, and in accordance with the purpose of the presently preferred embodiment as broadly described herein, the present application provides a method for defining a maintenance frequency of a product, comprising the steps of building a frequency expression for a product element based on a frequency expression language; and associating an action with said frequency expression. The method wherein said building step is done in a stepwise manner. The method further comprising the step of reviewing said frequency expression by a user for accuracy. The method further comprising the step of determining when a maintenance operation is required. The method wherein said determining step is based on said frequency expression and a current product age. The method further comprising the step of defining a frequency expression language. The method wherein said frequency expression language is for maintenance operations. The method wherein said frequency expression language is applicable to product element maintenance.

Another advantage of the presently preferred embodiment is to provide a computer-program product tangibly embodied in a machine readable medium to perform a method for defining a maintenance frequency of a product, comprising instructions for building a frequency expression for a product element based on a frequency expression language; and instructions for associating a product element with said frequency expression. The computer-program product, wherein said building step is done in a stepwise manner. The computer-program product, further comprising instructions for the step of reviewing said frequency expression by a user for accuracy. The computer-program product, further comprising instructions for the step of determining when a maintenance operation is required. The computer-program product, wherein instructions for the step of said determining is based on said frequency expression and a current product age. The computer-program product, further comprising instructions for the step of defining a frequency expression language. The computer-program product, wherein said frequency expression language is for maintenance operations. The computer-program product, wherein said frequency expression language is applicable to product element maintenance.

And another advantage of the presently preferred embodiment is to provide a data processing system having at least a processor and accessible memory to implement a method for defining a maintenance frequency of a product, comprising means for building a frequency expression for a product element based on a frequency expression language having a maintenance grammar; and means for associating an action with said frequency expression. The data processing system, said maintenance grammar is implemented in BNF.

Still another advantage of the presently preferred embodiment is to provide a data processing system having at least a processor and accessible memory to implement a method for defining a maintenance frequency of a product, comprising means for defining a frequency expression language. The data processing system, wherein said means is applicable to product element maintenance.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a flowchart of the major components for a system and method for defining a frequency expression language for product maintenance;

FIG. 2A-FIG. 2D define a maintenance grammar by use of a syntax graph;

FIG. 3 is a UML diagram of a FEL data model;

FIG. 4 is a UML diagram of the presently preferred embodiment;

FIG. 5 is an interface for the presently preferred embodiment; and

FIG. 6 is a block diagram of a computer environment in which the presently preferred embodiment may be practiced.

### DETAILED DESCRIPTION OF THE PREFERRED EMBODIMENTS

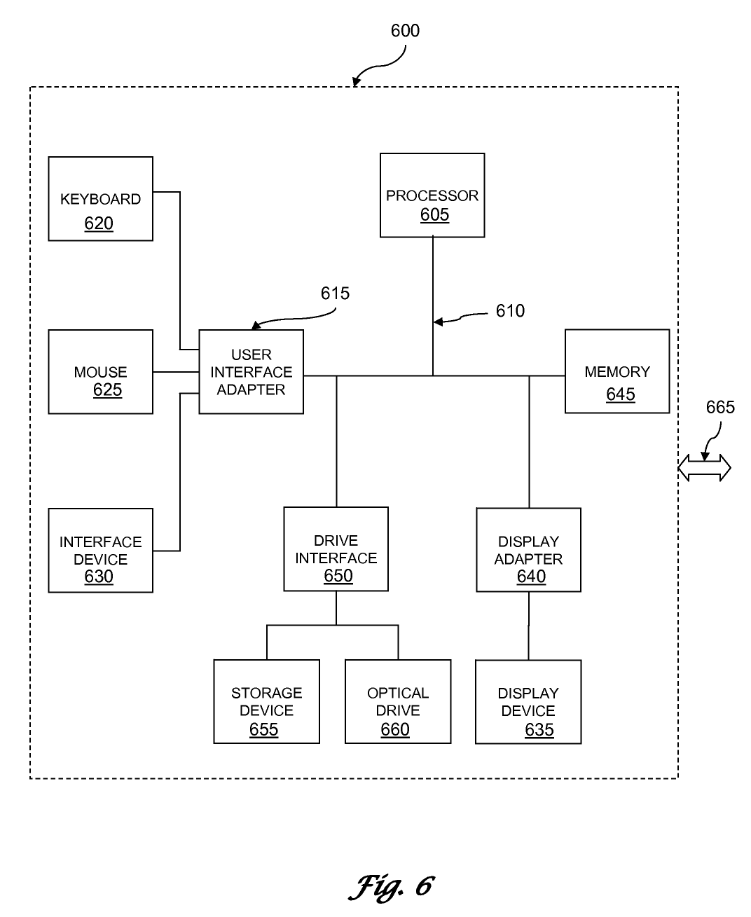

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method of defining a frequency expression language for product maintenance. Now therefore, in accordance with the presently preferred embodiment, an operating system executes on a computer, such as a general-purpose personal computer. FIG. 6 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implementation particular abstract data types. The presently preferred embodiment may be performed in any of a variety of known computing environments.

With reference to FIG. 6, an exemplary system for implementing the presently preferred embodiment includes a general-purpose computing device in the form of a computer 600, such as a desktop or laptop computer, including a plurality of related peripheral devices (not depicted). The computer 600 includes a microprocessor 605 and a bus 610 employed to connect and enable communication between the microprocessor 605 and a plurality of components of the computer 600 in accordance with known techniques. The bus 610 may be any of several types of bus structures including a memory bus or memory controller, a peripheral bus, and a local bus using any of a variety of bus architectures. The computer 600 typically includes a user interface adapter 615, which connects the microprocessor 605 via the bus 610 to one or more interface devices, such as a keyboard 620, mouse 625, and/or other interface devices 630, which can be any user interface device, such as a touch sensitive screen, digitized pen entry pad, etc. The bus 610 also connects a display device 635, such as an LCD screen or monitor, to the microprocessor 605 via a display adapter 640. The bus 610 also connects the microprocessor 605 to a memory 1645, which can include ROM, RAM, etc.

The computer 600 further includes a drive interface 650 that couples at least one storage device 655 and/or at least one optical drive 660 to the bus. The storage device 655 can include a hard disk drive, not shown, for reading and writing to a disk, a magnetic disk drive, not shown, for reading from or writing to a removable magnetic disk drive. Likewise the optical drive 660 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 600.

The computer 600 can communicate via a communications channel 665 with other computers or networks of computers. The computer 600 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 645 of the computer 600. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

### System

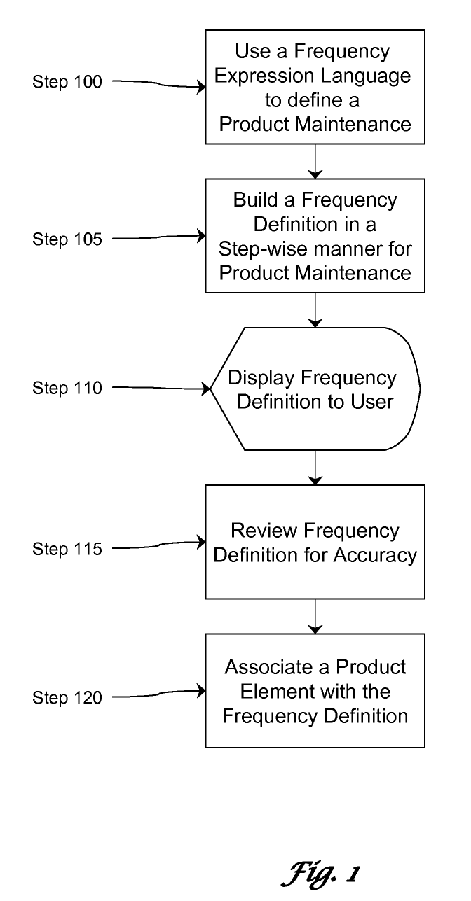

FIG. 1 is a flowchart of the major components for a system and method for defining a frequency expression language for product maintenance. Referring to FIG. 1, the presently preferred embodiment uses Backus Naur Form (BNF) to describe a maintenance grammar, referred to as a Frequency Expression Language (FEL) grammar, that defines a product maintenance frequency for a product (Step 100). Next, a user builds a frequency expression in a step-wise manner through a series of simple step inputs (Step 105). As the user defines the maintenance frequency through the frequency expression, the frequency expression is automatically generated and displayed (Step 110). This automatic generation and display provides the ability to review the frequency expression in plain English for accuracy (Step 115). The frequency expression is then associated with an action, where the action is a maintenance operation, e.g., maintenance, repair and/or overhaul (Step 120). The frequency expression is used to determine when the next maintenance is to be performed as the product ages using a current product age, where the current age is an operational age or the amount of time the product has been used versus the elapse of time from the create date of the product. BNF definition of Frequency Expression Language

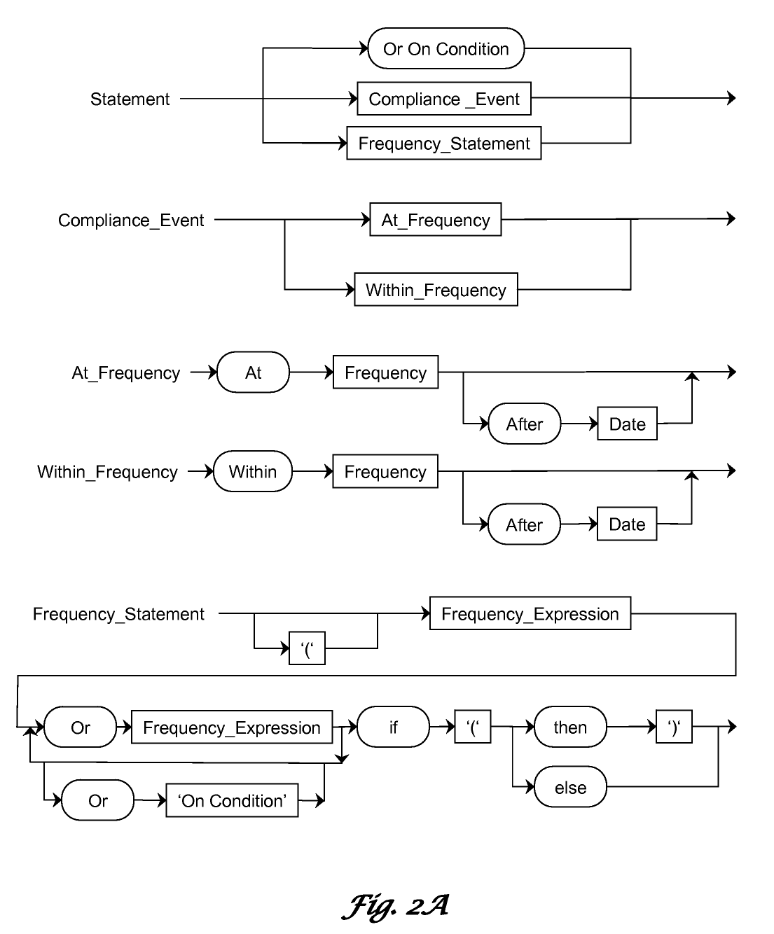

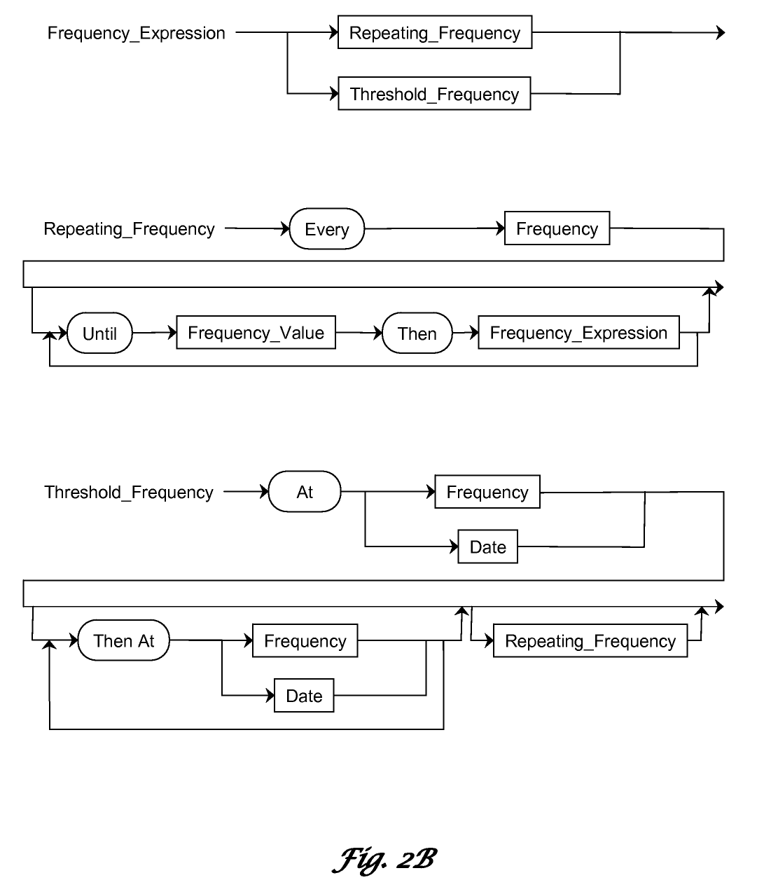

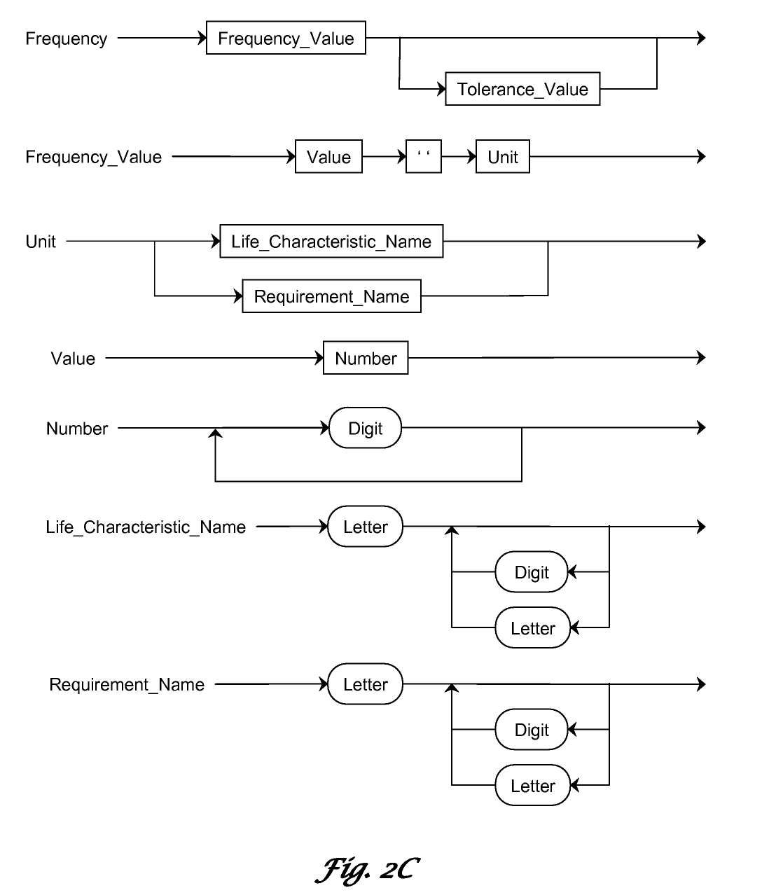

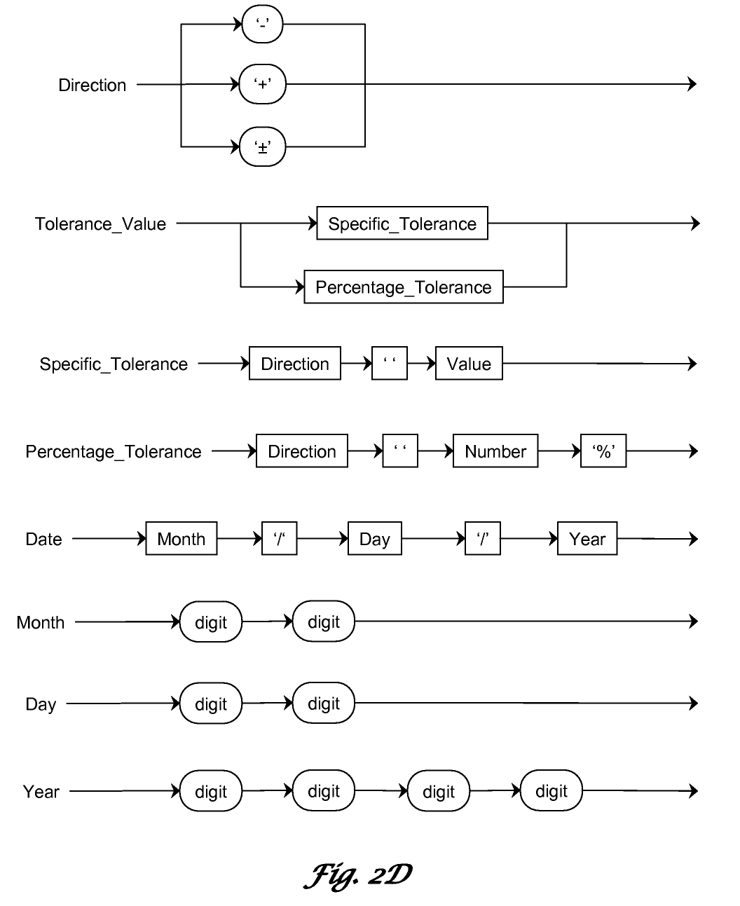

FIGS. 2A-2D define the maintenance grammar by use of a syntax graph. Referring to FIG. 2A, the Frequency Expression Language is expressed in BNF or Extended BNF (EBNF), where the grammar is:

<Statement>::=<Compliance_Event> | <Frequency_Statement> | On
Condition
<Compliance_Event>::=<At_Frequency> | <Within_Frequency>
<At_Frequency>::=At<Frequency>] [After <Date>]
<Within_Frequency>::=Within<Frequency> [After <Date>]
<Frequency_Statement>::=[‘(‘] <Frequency_Expression> {
Or
<Frequency_Expression> | [Or ‘On Condition’]} [‘)’]

Referring to FIG. 2B, the Frequency Expression Language is expressed in BNF or Extended BNF (EBNF), where the grammar is continued as:

<Fequency_Expression>::=<Repeating_Exprssion> |
<Threshold_Frequency>
<Repeating_Frequency>::=Every <Frequency > [ {Until
<Frequency_Value>
Then <Frequency_Expression> } ]
<Threshold_Frequency>::=At (<Frequency> | <Date>) [{Then At
(<Frequency> | <Date>)}] | [<Repeating_Frequency>]

Referring to FIG. 2C, the Frequency Expression Language is expressed in BNF or Extended BNF (EBNF), where the grammar is continued as:

<Frequency>::=<Frequency_Value> [ <Tolerance_Value>]
<Frequency_Value>::=<Value> ‘ ‘ <Unit>
<Unit>::=<Life_Characteristic_Name> | <Requirement_Name>
<Value>::=<Number>
<Number>::=digit { digit }
<Life_Characteristic_Name>::=letter { digit | letter }
<Requirement_Name>::=letter { digit | letter }

Referring to FIG. 2D, the Frequency Expression Language is expressed in BNF or Extended BNF (EBNF), where the grammar is continued as:

<Direction>::=‘−’ | ‘+’ | ‘±’
<Tolerance_Value>::=<Specific_Tolerance> | <Percentage_Tolerance>
<Specific_Tolerance>::=Direction> ‘ ‘ <Value>
<Percentage_Tolerance>::=<Direction> ‘ ‘ <Number> ‘%’
<Date>::=<month>/<day>/<year>
<month>::=digit digit
<day>::=digit digit
<year>::=digit digit digit digit

### Application of FEL to Data Model

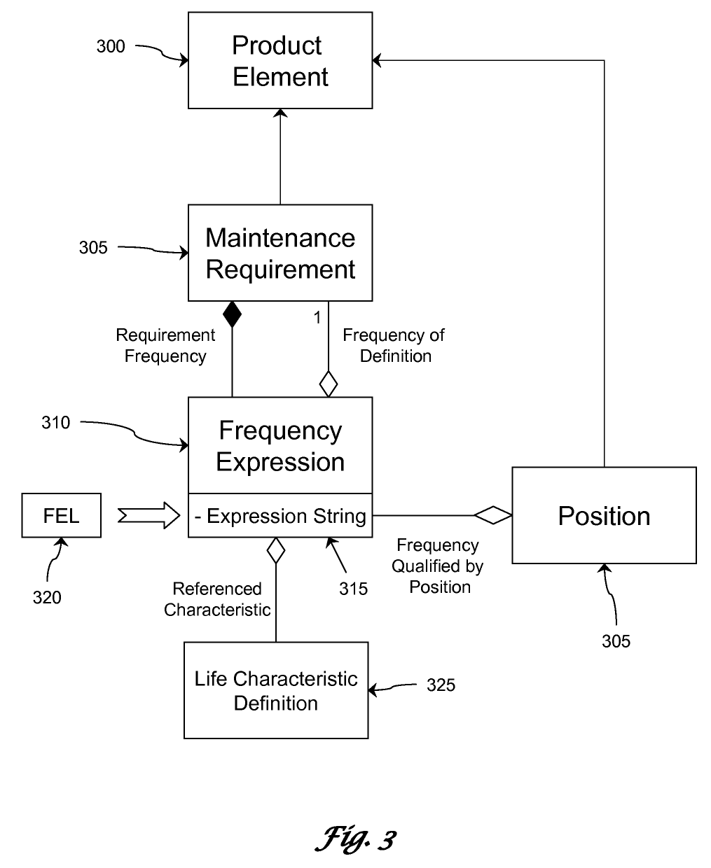

FIG. 3 is a UML diagram of a FEL data model. Referring to FIG. 3, a product element 300 has various components, and each component has a component location within the product element 300, where the component location is also known as a position 305. In multi-component assemblies, it is very common for there to be a neutral product that has a number of physical representations, e.g., an automobile might have one type of tire, a neutral product, but that single tire could have five separate positions, its physical representations. The neutral product has pre-defined maintenance requirements that need to be performed based on the frequency expression 310 comprised of one or more expression strings 315. For example, a tire should be rotated every 3 months and replaced every 50,000 miles or after 4 years of use. The aforementioned maintenance requirement on the neutral product is potentially modified according to various physical representations, e.g., the tires on the driver's side of the car are not rotated with the passenger-side tires, while the spare tire is never rotated. The expression string 315 is created by use of the FEL 320, and is further customized based on a Life Characteristic Definition (LCD) 325 that has Life Characteristic Values. An example of LCD is the term MONTH, and examples of LCV are 3 or 48, which means that the LCD of MONTH can have one of the values of 3 or 48.

### Application of the FEL

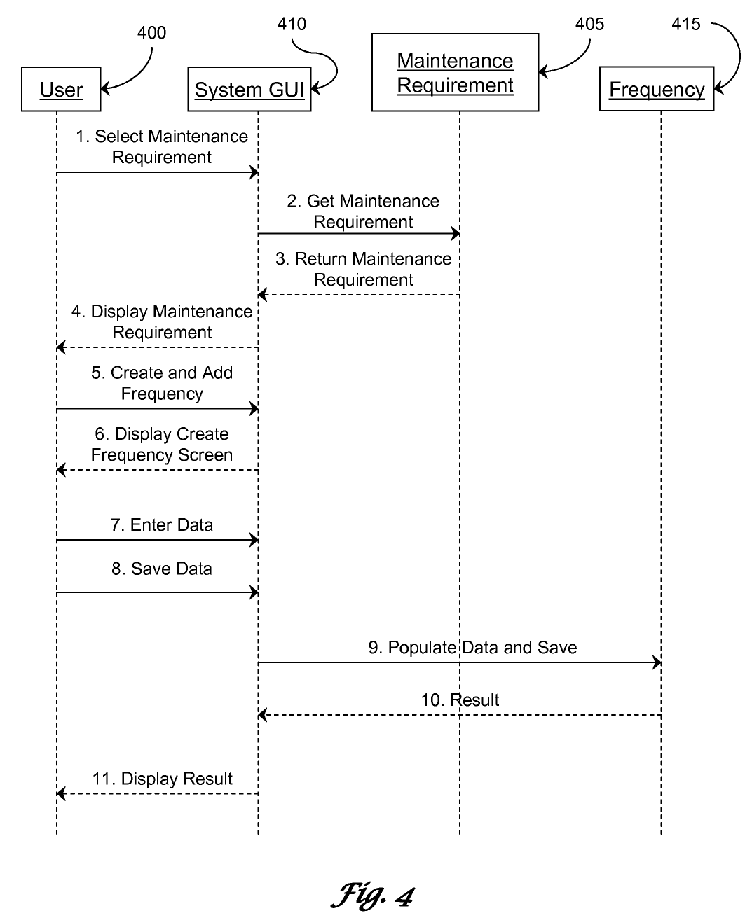

FIG. 4 is a UML diagram of the presently preferred embodiment. Referring to FIG. 4, the user 400 selects a maintenance requirement module 405 through a system graphical user interface (GUI) 410. From there the GUI initiates a request to the maintenance requirement module 405 to retrieve the maintenance requirement. The maintenance requirement 305 is displayed for viewing by the user 400. The user then requests the ability to create and add expression strings 315 to create the frequency expression 310. The GUI 410 displays a create screen, thereafter the user 400 enters one or more expression strings 315. The frequency expression 310 is saved and its data is populated to a frequency module 415. Lastly the frequency module 415 returns the stored frequency expression result to the user for display.

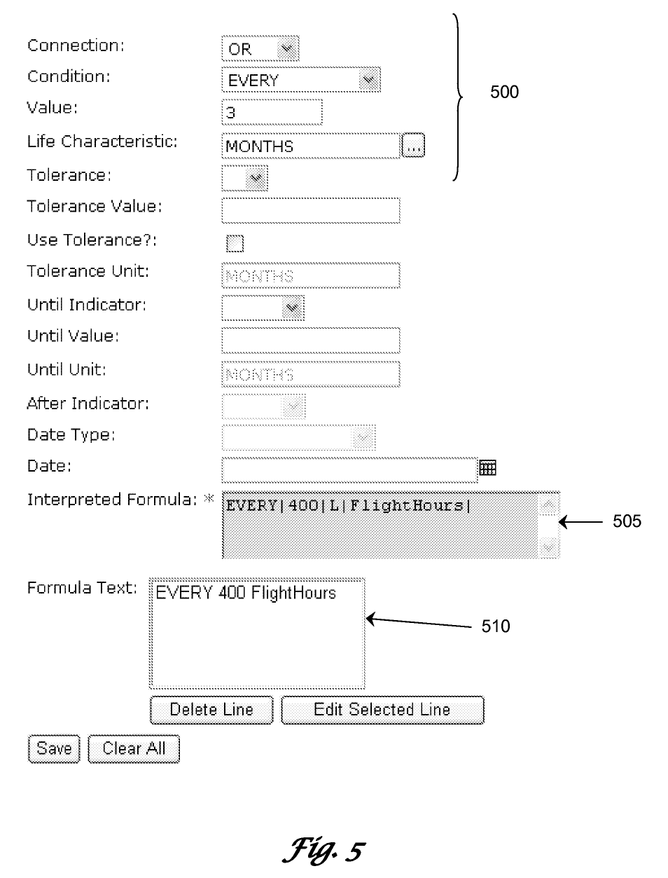

FIG. 5 is an interface for the presently preferred embodiment. Referring to FIG. 5, the user 400 accessed a part that already has the maintenance requirement 305 of “EVERY 400 FlightHours,” and the user 400 intends to add the expression string “OR EVERY 3 MONTHS” generally shown at 500. The pre-defined displayed LCD is MONTH, and the corresponding LCV is 3. The field noted as Interpreted Formula provides a formula window 505 with real time feedback to the user 400 while creating the expression string 315 inclusion in the frequency expression 310. Referring to the formula window 505, the expression string of “EVERY|400|L|FlightHours” indicates the choices made by the user 400, where the “L” informs the system that next is one of the Life Characteristics defined for the product. As the user saves the frequency expression, the interpreted Formula displays:

EVERY|400|L|FlightHours|OR|EVERY|3|L|MONTHS

A formula text window 510 displays feedback of the saved frequency expression 310 in an easy to read manner. After saving the new expression string 315, the user 400 views the frequency expression 310 in the frequency text window 510 as “EVERY 500 FlightHours OR EVERY 3 MONTHS.”

An alternative purpose of the presently preferred embodiment is to enable a user to read the maintenance requirement frequencies for a particular product element, and key-in those requirements into the disclosed system to build frequency expressions avoiding a complex translation task with a high likelihood of error. For example:

| Maintenance Manual Text | Frequency Expression |
|---|---|
| Battery must be replaced after 3 | 3 years FROM manufacture date |
| years from date of manufacture | OR AFTER 1 emergency |
| stamped on battery; or after | activation OR AFTER 1 hour |
| transmitter is used in an emergency | OR BY battery replacement |
| situation; or after the transmitter has | date |
| been operated for more than one | |
| cumulative hour; or on or before | |
| battery replacement date. | |
| Phase 8 consists of items to be | EVERY 400 hours ± 50 hours |
| inspected each 400, +50, −50 hours | OR 12 months |
| or 12 calendar months, whichever | |
| occurs first. | |
| Phase 14 consists of items to be | EVERY 10000 hours UNTIL |
| inspected at the first 10,000 hours | 10000 hours THEN |
| and 3000 hours thereafter. | 3000 hours |
| Phase 15 consists of items to be | EVERY 10000 hours UNTIL |
| inspected at the first 10,000 hours, at | 15000 hours THEN |
| 15,000 hours and every 1000 hours | 1000 hours |
| there after. | |
| Phase 49 consists of items to be | EVERY 2400 hours or 6 years |
| inspected at 6 years or 2400 hours, | UNTIL 2400 hours or 6 years |
| whichever occurs first, and then every | THEN 1200 hours or 36 months |
| 1200 hours or 36 calendar months, | |
| whichever occurs first. | |
| Comply within 100 hours, but no later | BY 100 hours OR Feb. 28, 1995 |
| than Feb. 28, 1995 | |
| Replace at engine overhaul. | BY engine overhaul |

From the frequency expressions noted in the above table, words and phrases in italics are defined in the LCD for a corresponding product element. For example, for the battery product an emergency activation LCD was defined, so that when the user 400 chose the Life Characteristic “emergency activation” for the battery product, that user then entered a value to indicate the battery must be replaced after 1 emergency activation. Likewise, the user 400 defines the LCD of hours to mean operational hours, and the LCD of years to mean actual computed time from create date to current date. Either way, the use of the FEL is dependant upon the intent authored by the user 400.

### Conclusion

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments have been described. It will be understood that various modifications may be made without departing from the spirit and scope of the presently preferred embodiment, such as an product manufacturer including maintenance requirements with a product BOM, and the disclosed system imports the maintenance-specific information. Likewise, OEMs email maintenance requirement updates that are automatically populated within a database for various frequency expressions. Alternatively, it can be determined when a part is due to fail based on use or time in service, and the disclosed system can notify the user to purchase a replacement from potential competitive vendors. Further, the FEL does not have to be defined in the Backus-Naur Form, but the use of any context-free grammar will also satisfy the same disclosed requirements, particularly noting that fewer syntax strings can be utilized without diverging from the scope of the presently preferred embodiment. Therefore, other implementations are within the scope of the following claims.

What is claimed is:

1. A method for defining a maintenance frequency of a product, comprising the steps of:
building a frequency expression for a product element based on a frequency expression language; and
associating an action with said frequency expression.

2. The method of claim 1, wherein said building step is done in a stepwise manner.

3. The method of claim 1, further comprising the step of reviewing said frequency expression by a user for accuracy.

4. The method of claim 1, further comprising the step of determining when a maintenance operation is required.

5. The method of claim 4, wherein said determining step is based on said frequency expression and a current product age.

6. The method of claim 1, further comprising the step of defining a frequency expression language.

7. The method of claim 6, wherein said frequency expression language is for maintenance operations.

8. The method of claim 6, wherein said frequency expression language is applicable to product element maintenance.

9. A computer-program product tangibly embodied in a machine readable medium to perform a method for defining a maintenance frequency of a product, comprising:
instructions for building a frequency expression for a product element based on a frequency expression language; and
instructions for associating a product element with said frequency expression.

10. The computer-program product of claim 9, wherein said building step is done in a stepwise manner.

11. The computer-program product of claim 9, further comprising instructions for the step of reviewing said frequency expression by a user for accuracy.

12. The computer-program product of claim 9, further comprising instructions for the step of determining when a maintenance operation is required.

13. The computer-program product of claim 12, wherein instructions for the step of said determining is based on said frequency expression and a current product age.

14. The computer-program product of claim 9, further comprising instructions for the step of defining a frequency expression language.

15. The computer-program product of claim 14, wherein said frequency expression language is for maintenance operations.

16. The computer-program product of claim 14, wherein said frequency expression language is applicable to product element maintenance.

17. A data processing system having at least a processor and accessible memory to implement a method for defining a maintenance frequency of a product, comprising:
means for building a frequency expression for a product element based on a frequency expression language having a maintenance grammar; and
means for associating an action with said frequency expression.

18. The data processing system of claim 17, said maintenance grammar is implemented in BNF.

19. A data processing system having at least a processor and accessible memory to implement a method for defining a maintenance frequency of a product, comprising:
means for defining a frequency expression language.

20. The data processing system of claim 19, wherein said means is applicable to product element maintenance.
